(19) United States
(12) Patent Application Publication
(10) Pub. No.: US 2007/0007487 A1
(43) Pub. Date: Jan. 11, 2007

(54) Refrigerant mixtures used in the lower temperature stage of two-stage cascade refrigeration systems

(75) Inventors: Jianfeng Wu, Beijing (CN); Maoqiong Gong, Beijing (CN); Yu Zhang, Beijing (CN)

Correspondence Address: VENABLE LLP, P.O. BOX 34385, WASHINGTON, DC, 20043-9998, US

(73) Assignee: Technical Institute of Physics and Chemistry, Chinese Academy of Sciences, Beijing (CN)

(21) Appl. No.: 11/482,065

(22) Filed: Jul. 7, 2006

(30) Foreign Application Priority Data
Jul. 8, 2005 (CN) 200510082824.9
Nov. 15, 2005 (CN) 200510123231.2

(51) Int. Cl. C09K 5/04

(52) U.S. Cl. 252/67

(57) ABSTRACT

Refrigerant mixtures used in the lower temperature stage of two-stage cascade refrigeration systems and obtained by physical mixing of ethane, hexafluoroethane, or/and trifluoromethane. One of the refrigerant mixtures comprises ethane and hexafluoroethane. Another refrigerant mixture comprises ethane and trifluoromethane. Yet another one of the refrigerant mixtures comprises ethane, hexafluoroethane, and trifluoromethane.

### FIELD OF THE INVENTION

The present invention relates to refrigerant mixtures. More particularly, the invention relates to refrigerant mixtures used in the lower temperature stage of two-stage cascade refrigeration systems.

### BACKGROUND OF THE INVENTION

With the development of science and technology, the need for refrigerators capable of operating the temperature of about −80° C. has become increasing, which is mainly used for biomaterial storage and seafood preservation. A single-stage vapor-compression cycle can only achieve an effective cooling temperature of about 40° C., and its practical efficiency is deteriorated greatly below −35° C. due to the decrease of the evaporating pressure. In order to reach lower temperature, the two-stage cascade refrigeration cycle, which uses the cooling power of a higher temperature vapor-compression cycle to cool a lower temperature stage, becomes a promising alternative. Each stage is independent cycle in two-stage cascade refrigeration cycle. In order to reach the cooling temperature of about −80° C., a two-stage cascade refrigeration cycle is usually employed. The evaporating temperature is usually from −30° C. to 40° C. in the first stage, which can be adjusted according to pressure variation of—refrigerant in the lower temperature stage and make sure that compressor of each stage works in the normal pressure range.

Chlorotrifluoromethane (R13), trifluoromethane (R23) and their mixture (R503) are refrigerants conventionally used in the lower temperature stage of two-stage cascade refrigeration systems, which can achieve the temperature of −80° C. R13 and R503 have been banned due to containing ozone-depleting chlorine and have been eliminated gradually. So R508 series, the mixture of R116 and R23 have been the substitute for R503. R508 series are categorized as R508A and R508B by different composition. The above substitute for R503 doesn't have ozone-depleting problem due to no containing chlorine, but it have enormous greenhouse effects with containing HFCs and HFs. In addition, the R508 series are poorly soluble with lubricants due to its whole component of HFCs and HFs, which could result in blocks in throttling elements due to solidification of lubricants in lower temperature ranges, and consequently lead to a reduction of system reliability. Propane (R290) or isobutane (R600a) has practically been added to high-quality lubricants in order to increase the solubility of R508 in lubricants and enhance system reliability in low temperature range. However, the good soluble characteristics of R290 or R600a with lubricants make a large amount of R290 and R600a dissolve in lubricants, which can lead to decrease the lubricative efficiency of compressor. In addition, cooling efficiency of refrigerant would also be reduced because high boiling point components are added to the system.

In conclusion, the refrigerants presently used in the lower temperature stage of cascade refrigeration systems are either ozone-depleting or have large greenhouse effects and poor solubility in lubricants.

### SUMMARY OF THE INVENTION

It is the objective of the present invention to provide refrigerant mixtures possessing no zone-depleting effects, low greenhouse effects and good solubility in lubricants at low temperatures in order to be used efficiently in the lower temperature stage of two-stage cascade refrigeration systems.

The present invention is directed to refrigerant mixtures used in the lower temperature stage of two-stage cascade refrigeration systems and obtained by physical mixing of ethane, hexafluoroethane, or/and trifluoromethane.

One of the refrigerant mixtures comprises ethane and hexafluoroethane, which the ethane is present in a concentration of 25 to 95 mole percent of the mixture and the hexafluoroethane is present in the rest portion of the mixture.

One of the refrigerant mixtures comprises ethane and trifluoromethane, which the ethane is present in a concentration of 45 to 75 mole percent of the mixture and the trifluoromethane is present in the rest portion of the mixture.

Another one of the refrigerant mixtures comprises ethane, hexafluoroethane and trifluoromethane, which the ethane is present in a concentration of 25 to 90 mole percent of the mixture, the hexafluoroethane is present in a concentration of 5 to 60 mole percent of the mixture and the trifluoromethane is present in the rest portion of the mixture.

All refrigerant mixtures disclosed herein have high thermodynamic efficiency and high evaporating pressures. Consequently, these mixtures have large cooling power under limited discharge capacity of compressors. Ozone Depleting Potential (ODP) values of the mixtures are zero and Global Warming Potential (GWP) values of the mixtures are greatly lower than the GWP values of R503 and R508B. Moreover, the mixtures are good soluble with lubricants.

### BRIEF DESCRIPTION OF THE DRAWINGS

FIG. 1 is a phase diagram of the refrigerant mixture comprising ethane and hexafluoroethane at the pressure of 101 kPa and 1320 kPa (T-x-y).

FIG. 2 is a phase diagram of the refrigerant mixture comprising ethane and trifluoromethane at the pressure of 101 kPa and 1320 kPa (T-x-y).

FIG. 3 is the evaporating pressure of the refrigerant mixture obtained by Example 16 and current refrigerants.

FIG. 4 is the temperature difference of bubble point and dew point of the refrigerant mixtures obtained by Example 6, Example 16 and R503 at different saturation pressure.

FIG. 5 is the performance of the refrigerant mixtures obtained by Example 6, Example 16 and R503 at different evaporating temperature.

Wherein COP is coefficient of performance.

### DETAILED DESCRIPTION OF THE INVENTION

The present invention provides a refrigerant mixture comprising ethane (C₂H₆, R170) and hexafluoroethane (C₂F₆, R116), which can be used in the lower temperature stage of two-stage cascade refrigeration systems. The ethane is present in a concentration of 25 to 95 mole percent and the hexafluoroethane is present in the rest portion of the mixture. Said ethane and said hexafluoroethane are mixed by physical method to obtain the mixture.

Preferably, said ethane is present in a concentration of 60 to 80 mole percent of the mixture (a concentration of 24.63 to 46.57 weight percent of the mixture) and said hexafluoroethane is present in the rest portion of the mixture. The preferred composition range is determined by achieving high coefficient of performance (COP) value for the refrigeration cycle, and considering the phase equilibrium behavior of the mixture to maintain the temperature difference of bubble point and dew point as small as possible. It should be mentioned that the temperature difference of bubble point and dew point is no larger than 2 K at one atmosphere within the above preferred composition range.

More preferably, said ethane is present in a concentration of 65.3 to 70 mole percent of the mixture (a concentration of 29.08 to 33.7 weight percent of the mixture) and said hexafluoroethane is present in the rest portion of the mixture.

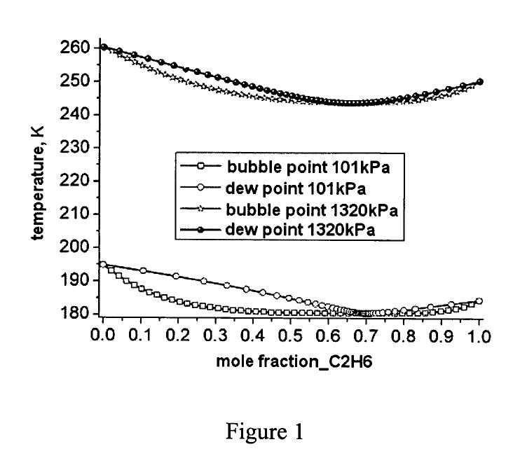

Azeotropic behaviors can be observed from the refrigerant mixtures disclosed herein. At the pressure of 101 kPa, the refrigerant consisting of about 0.7 mole fraction ethane and 0.3 mole fraction hexafluoroethane has an azeotropic temperature of 180.5 K (−92.65° C.). At the pressure of 1500 kPa, the refrigerant consisting of about 0.653 mole fraction ethane and 0.347 mole fraction hexafluoroethane has an azeotropic temperature of 248.0 K (−25.15° C.). In the lower temperature stage of cascade refrigeration system applications, the refrigerants generally have an evaporating temperature range of −90° C. to −65° C. corresponding to a pressure range of 100 kPa to 300 kPa, and a condensation temperature range of −45° C. to −25° C. corresponding to a pressure range of 900 kPa to 1500 kPa. In the above preferred composition range, the refrigerant mixture is azeotropic and behaves as a pure refrigerant with high COP value (shown in the FIG. 1).

The present invention provides another refrigerant mixture comprising ethane (C₂H₆, R170) and trifluoromethane (CHF₃, R23), which can be used in the lower temperature stage of two-stage cascade refrigeration systems. The ethane is present in a concentration of 45 to 75 mole percent of the mixture (a concentration of 26 to 56.3 weight percent of the mixture) and the trifluoromethane is present in the rest portion of the mixture. Said ethane and said trifluoromethane are mixed by physical method to obtain the mixture.

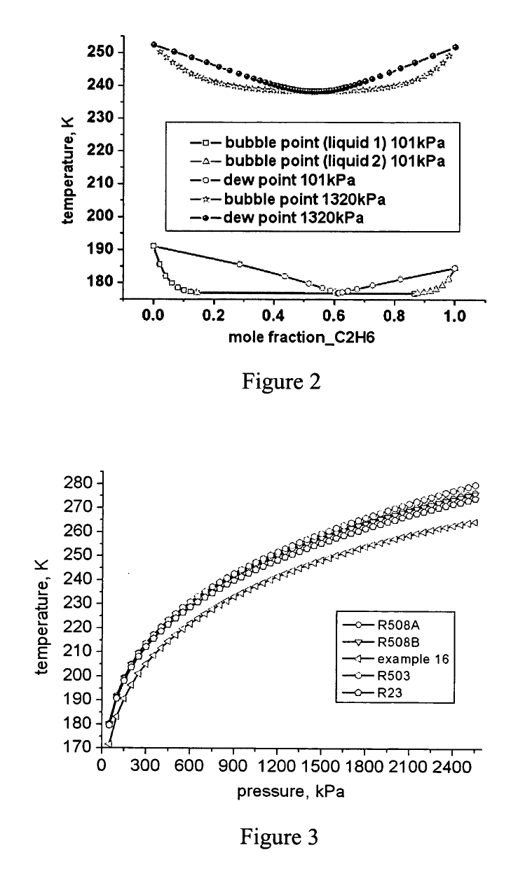

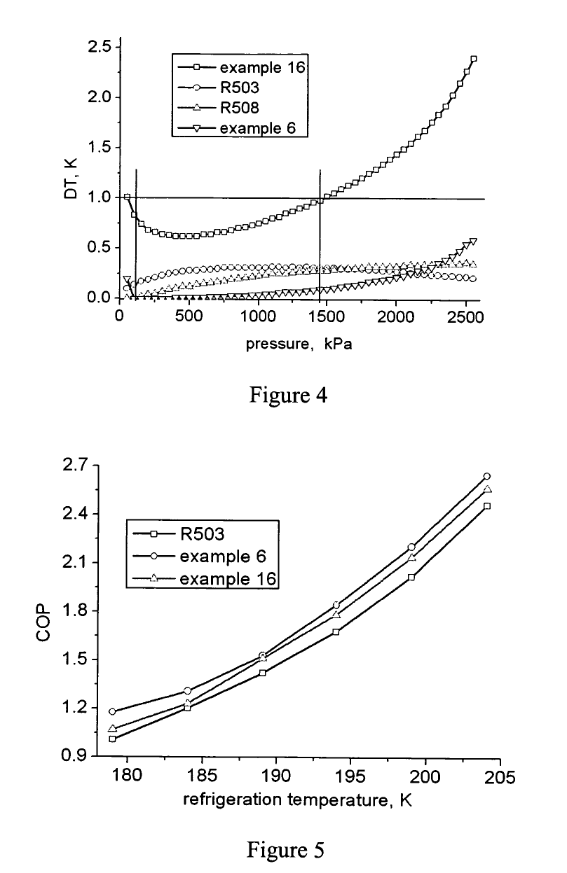

Preferably, said ethane is present in a concentration of 50 to 65 mole percent of the mixture and said trifluoromethane is present in the rest portion of the mixture. Azeotropic behavior can be observed from the refrigerant mixture disclosed herein above −87° C. The refrigerant has a high evaporating temperature that could enlarge the cooling power of refrigerators under the limited discharge capacity of compressors. In addition, a behavior of vapor-liquid-liquid equilibrium can be observed in the refrigerant mixture below −87° C. (shown in the FIG. 2).

The present invention provides another refrigerant mixture comprising ethane, hexafluoroethane and trifluoromethane, which can be used in the lower temperature stage of two-stage cascade refrigeration systems. The ethane is present in a concentration of 25 to 90 mole percent of the mixture, the hexafluoroethane is present in a concentration of 5 to 60 mole percent of the mixture and the trifluoromethane is present in the rest portion of the mixture. Said ethane, said hexafluoroethane and said trifluoromethane are mixed by physical method to obtain the mixture.

Preferably, said ethane is present in a concentration of 35 to 80 mole percent of the mixture, said hexafluoroethane is present in a concentration of 5 to 40 mole percent of the mixture and said trifluoromethane is present in the rest portion of the mixture.

More preferably, said ethane is present in a concentration of 40 to 55 mole percent of the mixture, said hexafluoroethane is present in a concentration of 5 to 20 mole percent of the mixture and said trifluoromethane is present in the rest portion of the mixture. Under the pressure range of 101 kPa to 1500 kPa, the refrigerant mixture is near azeotropic within the above composition range and the smallest temperature difference of bubble and dew point is within 1.5 K.

All refrigerant mixtures used in the lower temperature stage of two-stage cascade refrigeration system disclosed by the invention have the following advantages:

1. The refrigerant mixtures have zero Ozone Depletion Potential (ODP) value and could be used in the long-term systems without damaging the earth's ozone layer.

2. Involving natural ethane, all refrigerant mixtures disclosed by the invention have lower Global Warming Potential (GWP) value compared with conventional R23, R116, R13, and their mixtures, namely R503 and R508 series.

3. Another advantage of the invention is that all refrigerant mixtures disclosed herein have good solubility with lubricants. Traditional refrigerant mixtures, such as R508B, must be used with high-quality polyester (POE) lubricants added with either propane (R290) or isobutane (R600a) to increase their solubility with lubricants in low temperature range. On the contrary, all refrigerant mixtures disclosed herein have good solubility even with mineral oils (MO) or alkyl benzenes (AB) without adding propane or isobutane, and moreover, can be used as substitutes for a R503 refrigeration system without changing lubricant of the system.

4. All refrigerants disclosed by the invention have high evaporating and condensation pressure. The increase of the evaporating pressure could prevent refrigerators from operating in vacuum and also enlarge the cooling capacity of refrigerators without increasing the discharge capacity of compressors.

### PREFERED EMBODIMENTS OF THE INVENTION

### Example 1

At room temperature the ethane present in a concentration of 25 mole percent of the mixture and the hexafluoroethane present in a concentration of 75 mole percent of the mixture are mixed by physical method to obtain the refrigerant mixture used in the lower temperature stage of two-stage cascade refrigeration systems.

### Example 2

At room temperature the ethane present in a concentration of 30 mole percent of the mixture and the hexafluoroethane present in a concentration of 70 mole percent of the mixture are mixed by physical method to obtain the refrigerant mixture used in the lower temperature stage of two-stage cascade refrigeration systems.

### Example 3

At room temperature the ethane present in a concentration of 55 mole percent of the mixture and the hexafluoroethane present in a concentration of 45 mole percent of the mixture are mixed by physical method to obtain the refrigerant mixture used in the lower temperature stage of two-stage cascade refrigeration systems.

### Example 4

At room temperature the ethane present in a concentration of 60 mole percent of the mixture and the hexafluoroethane present in a concentration of 40 mole percent of the mixture are mixed by physical method to obtain the refrigerant mixture used in the lower temperature stage of two-stage cascade refrigeration systems.

### Example 5

At room temperature the ethane present in a concentration of 64 mole percent of the mixture and the hexafluoroethane present in a concentration of 36 mole percent of the mixture are mixed by physical method to obtain the refrigerant mixture used in the lower temperature stage of two-stage cascade refrigeration systems.

### Example 6

At room temperature the ethane present in a concentration of 65.3 mole percent of the mixture and the hexafluoroethane present in a concentration of 34.7 mole percent of the mixture are mixed by physical method to obtain the refrigerant mixture used in the lower temperature stage of two-stage cascade refrigeration systems.

### Example 7

At room temperature the ethane present in a concentration of 70 mole percent of the mixture and the hexafluoroethane present in a concentration of 30 mole percent of the mixture are mixed by physical method to obtain the refrigerant mixture used in the lower temperature stage of two-stage cascade refrigeration systems.

### Example 8

At room temperature the ethane present in a concentration of 75 mole percent of the mixture and the hexafluoroethane present in a concentration of 25 mole percent of the mixture are mixed by physical method to obtain the refrigerant mixture used in the lower temperature stage of two-stage cascade refrigeration systems.

### Example 9

At room temperature the ethane present in a concentration of 78 mole percent of the mixture and the hexafluoroethane present in a concentration of 22 mole percent of the mixture are mixed by physical method to obtain the refrigerant mixture used in the lower temperature stage of two-stage cascade refrigeration systems.

### Example 10

At room temperature the ethane present in a concentration of 80 mole percent of the mixture and the hexafluoroethane present in a concentration of 20 mole percent of the mixture are mixed by physical method to obtain the refrigerant mixture used in the lower temperature stage of two-stage cascade refrigeration systems.

### Example 11

At room temperature the ethane present in a concentration of 95 mole percent of the mixture and the hexafluoroethane present in a concentration of 5 mole percent of the mixture are mixed by physical method to obtain the refrigerant mixture used in the lower temperature stage of two-stage cascade refrigeration systems.

### Example 12

At room temperature the ethane present in a concentration of 25 mole percent of the mixture, the hexafluoroethane present in a concentration of 60 mole percent of the mixture and a trifluoromethane present in the concentration of 15 mole percent of the mixture are mixed by physical method to obtain the refrigerant mixture used in the lower temperature stage of two-stage cascade refrigeration systems.

### Example 13

At room temperature the ethane present in a concentration of 45 mole percent of the mixture, the hexafluoroethane present in a concentration of 30 mole percent of the mixture and the trifluoromethane present in a concentration of 25 mole percent of the mixture are mixed by physical method to obtain the refrigerant mixture used in the lower temperature stage of two-stage cascade refrigeration systems.

### Example 14

At room temperature the ethane present in a concentration of 55 mole percent of the mixture, the hexafluoroethane present in a concentration of 27 mole percent of the mixture and the trifluoromethane present in a concentration of 18 mole percent of the mixture are mixed by physical method to obtain the refrigerant mixture used in the lower temperature stage of two-stage cascade refrigeration systems.

### Example 15

At room temperature the ethane present in a concentration of 60 mole percent of the mixture, the hexafluoroethane present in a concentration of 25 mole percent of the mixture and the trifluoromethane present in a concentration of 15 mole percent of the mixture are mixed by physical method to obtain the refrigerant mixture used in the lower temperature stage of two-stage cascade refrigeration systems.

### Example 16

At room temperature the ethane present in a concentration of 64 mole percent of the mixture, the hexafluoroethane present in a concentration of 22 mole percent of the mixture and the trifluoromethane present in a concentration of 14 mole percent of the mixture are mixed by physical method to obtain the refrigerant mixture used in the lower temperature stage of two-stage cascade refrigeration systems. (Shown in FIG. 3)

### Example 17

At room temperature the ethane present in a concentration of mole 70 percent of the mixture, the hexafluoroethane present in a concentration of mole 19 percent of the mixture and the trifluoromethane present in a concentration of 11 mole percent of the mixture are mixed by physical method to obtain the refrigerant mixture used in the lower temperature stage of two-stage cascade refrigeration systems.

### Example 18

At room temperature the ethane present in a concentration of 75 mole percent of the mixture, the hexafluoroethane present in a concentration of 15 mole percent of the mixture and the trifluoromethane present in a concentration of 10 mole percent of the mixture are mixed by physical method to obtain the refrigerant mixture used in the lower temperature stage of two-stage cascade refrigeration systems.

### Example 19

At room temperature the ethane present in a concentration of 80 mole percent of the mixture, the hexafluoroethane present in a concentration of 12 mole percent of the mixture and the trifluoromethane present in a concentration of 8 mole percent of the mixture are mixed by physical method to obtain the refrigerant mixture used in the lower temperature stage of two-stage cascade refrigeration systems.

### Example 20

At room temperature the ethane present in a concentration of 90 mole percent of the mixture, the hexafluoroethane present in a concentration of 5 mole percent of the mixture and the trifluoromethane present in a concentration of 5 mole percent of the mixture are mixed by physical method to obtain the refrigerant mixture used in the lower temperature stage of two-stage cascade refrigeration systems.

### Example 21

At room temperature the ethane present in a concentration of 45 mole percent of the mixture and the trifluoromethane present in a concentration of 55 mole percent of the mixture are mixed by physical method to obtain the refrigerant mixture used in the lower temperature stage of two-stage cascade refrigeration systems.

### Example 22

At room temperature the ethane present in a concentration of 75 mole percent of the mixture and the trifluoromethane present in a concentration of 25 mole percent of the mixture are mixed by physical method to obtain the refrigerant mixture used in the lower temperature stage of two-stage cascade refrigeration systems.

### Example 23

At room temperature the ethane present in a concentration of 50 mole percent of the mixture and the trifluoromethane present in a concentration of 50 mole percent of the mixture are mixed by physical method to obtain the refrigerant mixture used in the lower temperature stage of two-stage cascade refrigeration systems.

### Example 24

At room temperature the ethane present in a concentration of 65 mole percent of the mixture and the trifluoromethane present in a concentration of 35 mole percent of the mixture are mixed by physical method to obtain the refrigerant mixture used in the lower temperature stage of two-stage cascade refrigeration systems.

### Example 25

At room temperature the ethane present in a concentration of 62 mole percent of the mixture and the trifluoromethane present in a concentration of 38 mole percent of the mixture are mixed by physical method to obtain the refrigerant mixture used in the lower temperature stage of two-stage cascade refrigeration systems.

### Example 26

At room temperature the ethane present in a concentration of 52 mole percent of the mixture and the trifluoromethane present in a concentration of 48 mole percent of the mixture are mixed by physical method to obtain the refrigerant mixture used in the lower temperature stage of two-stage cascade refrigeration systems.

Based on the calculated data of refrigeration cycles, the cycle performance parameters of the refrigerant mixtures obtained by above 26 examples and some currently used refrigerants are compared in Table 1.

TABLE 1
Comparisons Of Cycle Performance Parameters Between The Present Refrigerant
Mixtures And The Current Refrigerants

| | Composition | | | | | Discharging | | |
|---|---|---|---|---|---|---|---|---|
| | (percent by molar | | | Condensation | Evaporation | Temperature¹ | Relative | |
| | of the mixture) | | | Pressure¹ | Pressure¹ | Of | Cooling | Relative |
| Example | R170 | R116 | R23 | kPa | kPa | Compressor K | Power** | COP* |
| 1 | 25 | 75 | / | 1020 | 101 | 344.08 | 0.421 | 0.455 |
| 2 | 30 | 70 | / | 1040 | 101 | 347.54 | 0.699 | 0.745 |
| 3 | 55 | 45 | / | 1120 | 133 | 353.77 | 1.083 | 0.967 |
| 4 | 60 | 40 | / | 1130 | 145 | 352.93 | 1.186 | 1.014 |
| 5 | 64 | 36 | / | 1130 | 153 | 353.46 | 1.246 | 1.032 |
| 6 | 65.3 | 34.7 | / | 1140 | 154 | 354.30 | 1.266 | 1.040 |
| 7 | 70.0 | 30.0 | / | 1140 | 154 | 357.49 | 1.273 | 1.040 |
| 8 | 75 | 25 | / | 1140 | 154 | 359.47 | 1.284 | 1.041 |
| 9 | 78 | 22 | / | 1130 | 152 | 364.52 | 1.273 | 1.038 |
| 10 | 80 | 20 | / | 1120 | 150 | 366.45 | 1.255 | 1.031 |
| 11 | 95 | 5 | / | 1050 | 133 | 384.25 | 1.146 | 1.001 |
| 12 | 25 | 60 | 15 | 1020 | 94 | 356.89 | 0.775 | 0.858 |
| 13 | 45 | 30 | 25 | 1340 | 130 | 376.99 | 1.125 | 0.910 |
| 14 | 55 | 27 | 18 | 1320 | 147 | 371.79 | 1.260 | 0.966 |
| 15 | 60 | 25 | 15 | 1300 | 157 | 368.90 | 1.342 | 1.003 |
| 16 | 64 | 22 | 14 | 1320 | 165 | 369.58 | 1.413 | 1.021 |
| 17 | 70 | 19 | 11 | 1300 | 160 | 372.98 | 1.370 | 1.008 |
| 18 | 75 | 15 | 10 | 1320 | 160 | 377.64 | 1.376 | 0.998 |
| 19 | 80 | 12 | 8 | 1300 | 153 | 382.26 | 1.319 | 0.978 |
| 20 | 90 | 5 | 5 | 1250 | 140 | 392.64 | 1.216 | 0.946 |
| 21 | 45 | / | 55 | 1370 | 155 | 401.37 | 1.162 | 0.867 |
| 22 | 75 | / | 25 | 1370 | 160 | 397.28 | 1.182 | 0.873 |
| 23 | 50 | / | 50 | 1370 | 170 | 394.80 | 1.243 | 0.892 |
| 24 | 65 | / | 35 | 1370 | 180 | 390.09 | 1.316 | 0.934 |
| 25 | 62 | / | 38 | 1367 | 191 | 386.66 | 1.386 | 0.960 |
| 26 | 52 | / | 48 | 1370 | 175 | 392.72 | 1.281 | 0.916 |

Comparisons with currently used refrigerants***

| | | | | | | | | |
|---|---|---|---|---|---|---|---|---|
| R503 | / | / | / | 999 | 124 | 380.15 | 1.0 | 1.0 |
| R13 | / | / | / | 717 | 83 | 365.15 | 0.71 | 1.05 |
| R23 | / | / | / | 848 | 90 | 411.15 | 0.74 | 0.95 |
| R508B | / | / | / | 1013 | 124 | 358.15 | 0.98 | 1.03 |

¹All parameters in Table 1 were calculated under such condition: the condensation temperature is 238 K; the subcooling temperature is 5.6 K; the refrigeration temperature is 189 K; the suction temperature of compressor is 255.35 K; the isentropic compression efficiency is 70%; the calculated result is reckon without the efficiency of the higher temperature stage.
*Relative COP is divided by that of R503 based on the assumption that COP_{R503} is 1.0.
**Comparison of relative cooling power is obtained under the same compressor capacity. Relative cooling power is multiplied specific discharging cooling power by ratio of backpressure, said ratio of backpressure is the ratio of the evaporating pressure of the present refrigerant and R503.
***All parameters of currently used refrigerants such as R503, R13, R23 and R508B are cited from documents of the DuPont Ltd. (see http://www.dupont.com/suva/na/usa/literature/pdf/h65923-3.pdf).

All refrigerants provided by the invention are more environmental-friendly substitutes used for the lower temperature stage of two-stage cascade refrigeration systems. The ODP and GWP values of the refrigerant mixtures obtained by example 6 and 16 and some current refrigerants are compared in Table 2. From the data in Table 2, it can be seen that the GWP value is greatly reduced due to using the refrigerant mixtures provided by the invention.

TABLE 2
Comparisons Of ODP And GWP Values Between The Refrigerant Mixtures
Obtained By Example 6 And 16 And Current Refrigerants

| | Composition in mole percent | | | | | |
|---|---|---|---|---|---|---|
| | (mass percent) | | | | | |
| Refrigerant | R13 | R23 | R116 | R170 | ODP | GWP |
| Example 6 | / | / | 34.7 (70.9) | 65.3 (29.1) | 0.0 | 8443** |
| Example | / | 14 (16.5) | 22 (51.1) | 64 (32.4) | 0.0 | 8067** |
| 16 | | | | | | |
| R13* | 100 | / | | / | 1.0 | 14000 |
| R23* | / | 100 | | / | 0.0 | 12000 |
| R503* | 50.0 (59.9) | 50.0 (40.1) | / | / | 0.599 | 13000 |
| R508B* | / | 62.7 (46) | 37.3 (54) | / | 0.0 | 12000 |

*D. S. Cao, S. Lin, Manual of Refrigerants, Beijing: Metallurgical Industry Press, 2003. (Chinese edition).
**The GWP values of Formulae are weighted according to each component's GWP value.

As such, the present invention has been described in detail with references to particularly preferred embodiments and practicing Formulae as set forth above and provides new and useful refrigerant compositions of great novelty and utility. Of course, those skilled in the art to which the invention pertains should appreciate that various modifications and improvements may be made without departing from the spirit and scope of the claims that follow, and all embodiments discussed above should not be interpreted in a limiting sense.

We claim:

1. A refrigerant mixture used in the lower temperature stage of two-stage cascade refrigeration systems comprising:
the ethane present in a concentration of 25 to 95 mole percent of the mixture;
and the hexafluoroethane present in the rest portion of the mixture;
said ethane and said hexafluoroethane being mixed by physical method to obtain the mixture.

2. A refrigerant mixture used in the lower temperature stage of two-stage cascade refrigeration systems in accordance with claim 1, wherein the ethane is present in a concentration of 60 to 80 mole percent of the mixture and the hexafluoroethane is present in the rest portion of the mixture.

3. A refrigerant mixture used in the lower temperature stage of two-stage cascade refrigeration systems in accordance with claim 1, wherein the ethane is present in a concentration of 65.3 percent to 70 mole percent of the mixture and the hexafluoroethane is present in the rest portion of the mixture.

4. A refrigerant mixture used in the lower temperature stage of two-stage cascade refrigeration systems comprising:
the ethane present in a concentration of 45 to 75 mole percent of the mixture;
and the trifluoromethane present in the rest portion of the mixture;
said ethane and said trifluoromethane being mixed by physical method to obtain the mixture.

5. A refrigerant mixture used in the lower temperature stage of two-stage cascade refrigeration systems in accordance with claim 4, wherein the ethane is present in a concentration of 50 to 65 mole percent of the mixture and the trifluoromethane is present in the rest portion of the mixture.

6. A refrigerant mixture used in the lower temperature stage of two-stage cascade refrigeration systems comprising:
the ethane present in a concentration of 25 to 90 mole percent of the mixture;
the hexafluoroethane present in a concentration of 5 to 60 mole percent of the mixture;
and the trifluoromethane present in the rest portion of the mixture;
said ethane, said hexafluoroethane and said trifluoromethane being mixed by physical method to obtain the mixture.

7. A refrigerant mixture used in the lower temperature stage of two-stage cascade refrigeration systems in accordance with claim 6, wherein the ethane is present in a concentration of 35 to 80 mole percent of the mixture, the hexafluoroethane is present in a concentration of 5 to 40 mole percent of the mixture and the trifluoromethane is present in the rest portion of the mixture.

8. A refrigerant mixture used in the lower temperature stage of two-stage cascade refrigeration systems in accordance with claim 6, wherein the ethane is present in a concentration of 40 to 55 mole percent of the mixture, the hexafluoroethane is present in a concentration of 5 to 20 mole percent of the mixture and the trifluoromethane is present in the rest portion of the mixture.
